(19) United States
(12) Patent Application Publication
(10) Pub. No.: US 2008/0218133 A1
(43) Pub. Date: Sep. 11, 2008

(54) SIGNAL GENERATING APPARATUS AND METHOD THEREOF

(76) Inventor: Chien-Wei Kuan, Tai-Tung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/740,886

(22) Filed: Apr. 26, 2007

(30) Foreign Application Priority Data
Mar. 5, 2007 (TW) 096107538

(51) Int. Cl. G05F 1/10; G06F 1/04

(52) U.S. Cl. 323/234; 327/298

(57) ABSTRACT

The present invention discloses a signal generating apparatus for generating a clock signal, the signal generating apparatus includes: an adjusting module for generating an adjusting current according to a first reference voltage and a control voltage; and a clock signal generating module coupled to the adjusting module. The clock signal generating module includes: a current generating unit for generating a first current; a signal generating unit coupled to the current generating unit and the adjusting module for generating a voltage signal according to a second current, wherein the second current is generated according to the first current and the adjusting current; and a comparing unit coupled to the signal generating unit and a second reference voltage for comparing the voltage signal and the second reference voltage to generate the clock signal.

### BACKGROUND OF THE INVENTION

1. Field of the Invention

The present invention relates to a signal generating apparatus, and more particularly to a signal generating apparatus utilized for implementing a power supply circuit, wherein the signal generating apparatus comprises an on-chip adjusting module for adjusting the on-time of an internally generated clock signal, and a method thereof.

2. Description of the Prior Art

In the field of conventional pulse width modulation (PWM) control circuits or pseudo-fixed frequency control circuits, stability is always inversely proportional to the transient response time of control circuits. When a converting ratio of voltage of the buck regulator is higher, the stability is also required to be higher. However, this will worsen the transient recovering characteristic of the control circuits and thus a drop or overshot phenomenon will occur in the output voltage. In an integrated circuit (IC) application, the voltage feedback method (VPM), which is utilized for adjusting the output power of the buck regulator, has a transient response that is slower than the transient response of the current feedback method (CPM). For both the PWM control circuit and the pseudo-fixed frequency control circuit, the on-time (or the off-time) of the control clock is controlled by the feedback compensation signal. Furthermore, the feedback compensation signal will require a large phase margin of the circuit for the sake of stability, but this will also cause the drop or overshot phenomenon to occur in the output voltage, meaning the output voltage cannot return to the normal value quickly. Therefore, a novel voltage-feedback buck regulator that has good stability and transient response is becoming an important issue in the field of circuit design.

Please refer to FIG. 1. FIG. 1 is a diagram illustrating a prior art power supply circuit 10. The power supply circuit 10 comprises an on-time calculating circuit 11, a flip-flop 12, a switching logic circuit 13, an output stage circuit 14, a transconducting circuit 15, a current comparator 16, a delaying circuit 17, and an AND gate. The on-time calculating circuit 11 is coupled to a predetermined on-time Ton, an input voltage VIN and an output voltage VOUT, for calculating the on-time TON according to the input voltage VIN and the output voltage VOUT. The reset terminal R of the flip-flop 12 is coupled to the on-time calculating circuit 11, and the set terminal S is coupled to the AND gate 18. The switching logic circuit 13 controls the output stage circuit 14 to generate the output voltage VOUT to a loading circuit according to the clock signal outputted by the flip-flop 12. The transconducting circuit 15 compares a divided voltage of the output voltage VOUT of the output stage circuit 14 and a reference voltage VREF to generate a current, in which the current is utilized for charging an RC filter 19. The current comparator 16 compares the current generated by the transconducting circuit 15 and an output current IOUT generated by the output stage circuit 14 to generate a compared output. The delay circuit 17 outputs a high voltage level after a delay of the minimum off-time T_{OFF} when the falling edge of the clock signal occurs. When the two input terminals of the AND gate 18 are at a high voltage level, the AND gate 18 outputs a triggering signal to the set terminal S of the flip-flop 12 to control the duty cycle of the clock signal. However, as the RC filter 19 of the prior art power supply circuit 10 is implemented externally from the chip (i.e., off-chip), resulting in the RC time constant of the RC filter 19 being too large, the RC filter is unable to respond to the instant variation of the output voltage VOUT.

### SUMMARY OF THE INVENTION

Therefore, one of the objectives of the present invention is to provide a power supply circuit implemented by a signal generating apparatus, wherein the signal generating apparatus comprises an on-chip adjusting module for adjusting the on-time of an internally generated clock signal, and a method thereof.

According to an embodiment of the present invention, a signal generating apparatus for generating a clock signal is disclosed. The signal generating apparatus comprises an adjusting module and a clock signal generating module. The adjusting module generates an adjusting current according to a first reference voltage and a control voltage, where the clock signal generating module is coupled to the adjusting module. The clock signal generating module comprises a current generating unit, a signal generating unit, and a comparing unit. The current generating unit generates a first current. The signal generating unit is coupled to the current generating unit and the adjusting module for generating a voltage signal according to a second current, wherein the second current is generated according to the first current and the adjusting current. The comparing unit is coupled to the signal generating unit and a second reference voltage for comparing the voltage signal and the second reference voltage to generate the clock signal.

According to a second embodiment of the present invention, a power supply circuit for generating an output voltage according to an input control voltage is disclosed. The power supply circuit comprises a clock signal generating module, a duty cycle controlling device, an output stage device, a detecting device, and an adjusting module. The clock signal generating module generates a clock signal. The duty cycle controlling device is coupled to the clock signal generating module for setting a duty cycle of a controlling clock signal according to the clock signal and a triggering signal, and outputting the controlling clock signal. The output stage device is coupled to the duty cycle controlling device for generating the output voltage and an output current corresponding to the output voltage according to the controlling clock signal. The detecting device is coupled to the output stage device for detecting the output voltage and the output current to generate the triggering signal to the duty cycle controlling device. The adjusting module is coupled to the clock signal generating module and the output stage device for outputting an adjusting signal to the clock signal generating module for adjusting the clock signal according to the output voltage and a first reference voltage.

According to a third embodiment of the present invention, a signal generating method for generating a clock signal is disclosed. The signal generating method comprises the steps of: generating an adjusting current according to a first reference voltage and a control voltage; generating a first current; generating a voltage signal according to a second current, wherein the second current is generated according to the first current and the adjusting current; and comparing the voltage signal and a second reference voltage in order to generate the clock signal.

According to a fourth embodiment of the present invention, a power supplying method for generating an output voltage according to an input control voltage is disclosed. The power supplying method comprises the steps of: generating a clock signal; setting a duty cycle of a controlling clock signal according to the clock signal and a triggering signal, and outputting the controlling clock signal; generating the output voltage and an output current corresponding to the output voltage according to the controlling clock signal; detecting the output voltage and the output current to generate the triggering signal to the duty cycle controlling device; and outputting an adjusting signal to adjust the clock signal according to the output voltage and a first reference voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art power supply circuit.

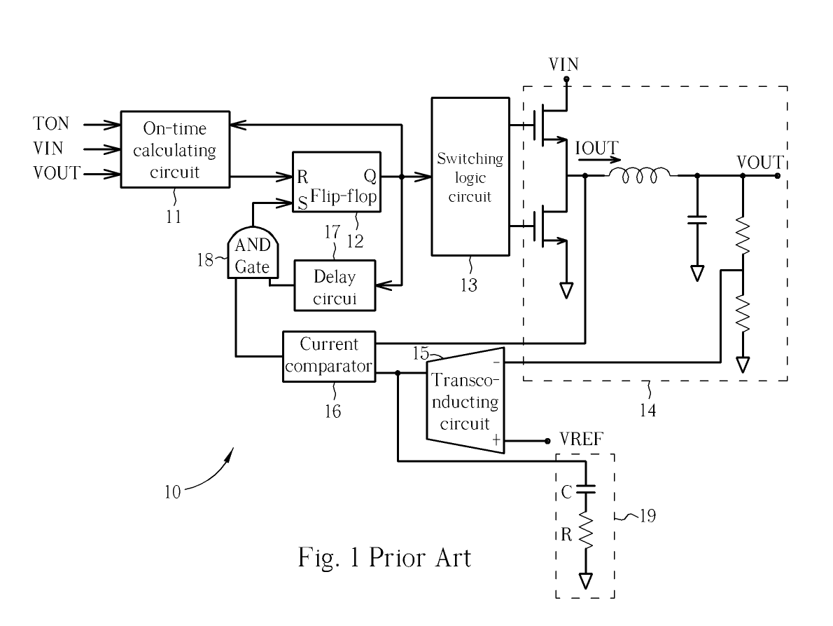

FIG. 2 is a diagram illustrating a power supply circuit according to an embodiment of the present invention.

FIG. 3 is a diagram illustrating the clock signal generating module of the power supply circuit according to an embodiment of the present invention.

FIG. 4 is a diagram illustrating the adjusting module of the power supply circuit according to a first embodiment of the present invention.

FIG. 5 is a transfer diagram between the comparing voltage and the output current of the adjusting module of the power supply circuit as shown in FIG. 2.

FIG. 6 is a timing diagram illustrating the clock signal of the clock signal generating module when adjusted by the adjusting module as shown in FIG. 2.

FIG. 7 is a diagram illustrating the adjusting module of the power supply circuit according to a second embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

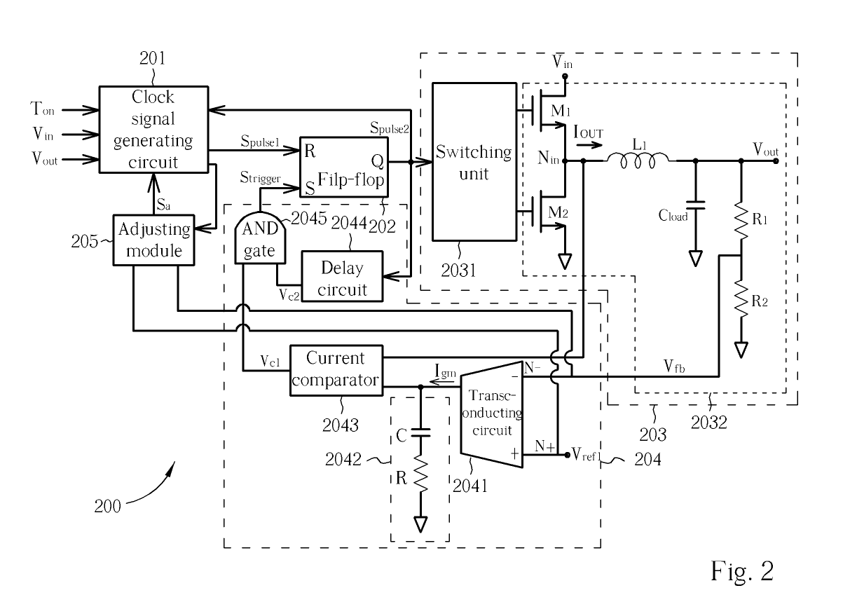

Please refer to FIG. 2. FIG. 2 is a diagram illustrating a power supply circuit 200 according to an embodiment of the present invention, in which the power supply circuit 200 generates an output voltage Vₒᵤₜ according to an input control voltage Vᵢₙ, the power supply circuit 200 comprises a clock signal generating module 201, a duty cycle controlling device 202, an output stage device 203, a detecting device 204, and an adjusting module 205. The clock signal generating module 201 generates a clock signal Sₚᵤₗₛₑ₁. The duty cycle controlling device 202 is coupled to the clock signal generating module 201 for setting a duty cycle of a controlling clock signal Sₚᵤₗₛₑ₂ according to the clock signal Sₚᵤₗₛₑ₁ and a triggering signal S_{trigger}, and outputting the controlling clock signal Sₚᵤₗₛₑ₂. The output stage device 203 is coupled to the duty cycle controlling device 202 for generating the output voltage Vₒᵤₜ and an output current Iₒᵤₜ that corresponds to the output voltage Vₒᵤₜ according to the controlling clock signal Sₚᵤₗₛₑ₂. The detecting device 204 is coupled to the output stage device 203 for detecting the output voltage Vₒᵤₜ and the output current Iₒᵤₜ to generate the triggering signal S_{trigger} to the duty cycle controlling device 202. The adjusting module 205 is coupled to the clock signal generating module 201 and the output stage device 203 for outputting an adjusting signal Sₐ to the clock signal generating module 201 to adjust the clock signal Sₚᵤₗₛₑ₁ according to the output voltage Vₒᵤₜ and a first reference voltage V_{ref1}, wherein the output voltage Vₒᵤₜ can be viewed as a control voltage of the adjusting module 205.

According to the embodiment, the duty cycle controlling device 202 can be implemented by an RS flip-flop, wherein the reset terminal R of the RS flip-flop is coupled to the clock signal Spulse1, and the set terminal S is coupled to the triggering signal S_{trigger} of the detecting device 204. The output stage device 203 comprises a switching unit 2031 and an output circuit 2032. The output circuit 2032 comprises two cascaded transistors M₁, M₂, a inductor L₁, a capacitor C_{load}, and two series connected voltage dividing resistors R₁, R₂, in which the connectivity between each element can be seen by referring to FIG. 2, and is thus omitted here for brevity. The detecting device 204 comprises a transconducting circuit 2041, a filtering circuit 2042 that comprises a series connected capacitor and resistor, a current comparator 2043, a delay circuit 2044, and an AND gate 2045. The transconducting circuit 2041 comprises a negative input terminal N− that is coupled to the dividing node of the voltage dividing resistors R₁, R₂, i.e., an output feedback voltage V_{fb}, and a positive input terminal N+ coupled to the first reference voltage V_{ref1}. The transconducting circuit 2041 compares the output feedback voltage V_{fb} and the first reference voltage V_{ref1} to generate a comparing current I_{gm} for charging the filtering circuit 2042. The current comparator 2043 is coupled to the connecting node N_{M} of the cascaded transistors M₁, M₂ and the comparing current I_{gm} for comparing the output current Iₒᵤₜ and the comparing current I_{gm} to output a compared voltage level V_{c1} at an input terminal of the AND gate 2045. The delay circuit 2044 detects the occurrence of the falling edge of the controlling clock signal Sₚᵤₗₛₑ₂ and outputs a voltage level V_{c2} to another input terminal of the AND gate 2045 after delaying by at least the minimum time T_{OFF}. When the compared voltage level V_{c1} and the voltage level V_{c2} are at a high voltage level at the same time, the AND gate 2045 outputs the triggering signal S_{trigger} to trigger the RS flip-flop. Please note that, according to the embodiment of the present invention, the transistors M1, M2, the inductor L1, the capacitor Cload, the voltage dividing resistors R₁, R₂, and the filtering circuit 2042 are installed externally of the chip, and the other elements of the power supply circuit 200 are installed within the chip. Therefore, those skilled in this art will readily understand that a pad is installed between the external components and the chip for communication between the external components and the chip, and the pad is not shown in FIG. 2 for the sake of brevity.

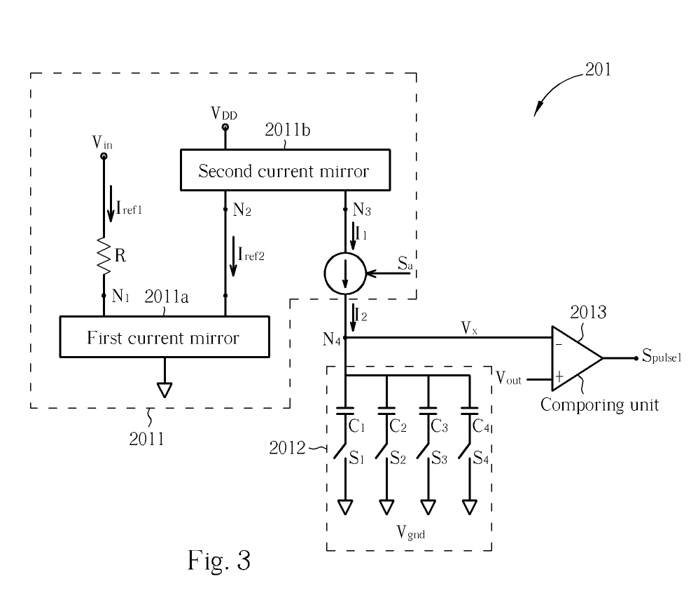

Please refer to FIG. 3. FIG. 3 is a diagram illustrating the clock signal generating module 201 of the power supply circuit 200 according to an embodiment of the present invention. The clock signal generating module 201 comprises a current generating unit 2011, a signal generating unit 2012, and a comparing unit 2013. The current generating unit 2011 generates a first current I₁, and comprises a resistor R coupled to the input control voltage Vᵢₙ for generating a reference current I_{ref1}=Vᵢₙ/R, and the other terminal of the resistor R is coupled to a first current mirror 2011a. A reference current terminal N₁ of the first current mirror 2011a receives the reference current I_{ref1}, and the first current mirror 2011a mirrors the reference current I_{ref1} to generate an output current I_{ref2} at an output current terminal N₂, wherein the output current terminal N₂ is coupled to a reference current terminal of a second current mirror 2011b. Furthermore, the second current mirror 2011b mirrors the output current I_{ref2} to generate the first current I₁ at an output current terminal N₃. The signal generating unit 2012 is coupled to the output terminal N₄ of the current generating unit 2011 and the comparing unit 2013 for generating a voltage signal Vₓ according to a second current I₂, wherein the second current I₂ is generated in accordance with the first current I₁ and the adjusting signal Sₐ. The comparing unit 2013 is coupled to the signal generating unit 2012 and a second reference voltage, in which the second reference voltage is the predetermined output voltage Vₒᵤₜ of the embodiment power supply circuit 200 of the present invention. Therefore, the comparing unit 2013 compares the voltage signal Vₓ and the predetermined output voltage Vₒᵤₜ for generating the clock signal Sₚᵤₗₛₑ₁. The signal generating unit 2012 in the signal generating module 201 is implemented by a plurality of capacitors C₁˜C₄ and a plurality of switches S₁˜S₄, in which the capacitors C₁˜C₄ are connected in parallel to the switches S₁˜S₄. Furthermore, each of the switches S₁˜S₄ selectively controls the corresponding capacitor (i.e., C₁˜C₄) to connect to the ground voltage V_{gnd} for controlling the frequency of the clock signal Sₚᵤₗₛₑ₁. For example, when all of the switches S₁˜S₄ couple all of the capacitors C₁˜C₄ to the ground voltage V_{gnd}, the clock signal Sₚᵤₗₛₑ₁ has the lowest frequency; and the fewer the switches coupling the capacitor to ground voltage, the higher the frequency of the clock signal Sₚᵤₗₛₑ₁. In other words, the frequency of the clock signal Sₚᵤₗₛₑ₁ is adjusted by the capacitors C₁˜C₄ and the magnitude of the second current I₂, but does not depend on an oscillating device. Therefore, the power supply circuit 200 is called a pseudo-frequency power supply circuit, and the pseudo-frequency is 1/(R*Cₜₒₜₐₗ), wherein Cₜₒₜₐₗ is the equivalent capacitance between the capacitors C₁˜C₄ and the ground voltage V_{gnd}, which is controlled by the switches S₁˜S₄. The power supply circuit 200 further comprises a discharging switch (not shown in the FIG. 3), which is coupled between the output current terminal N₃ and the ground voltage V_{gnd}. The discharging switch is controlled by the controlling clock signal Sₚᵤₗₛₑ₂. When the controlling clock signal Sₚᵤₗₛₑ₂ switches into the low voltage level, the discharging switch connects the capacitors C₁˜C₄ to ground for discharging, therefore making the voltage signal Vₓ return to the ground voltage V_{gnd}.

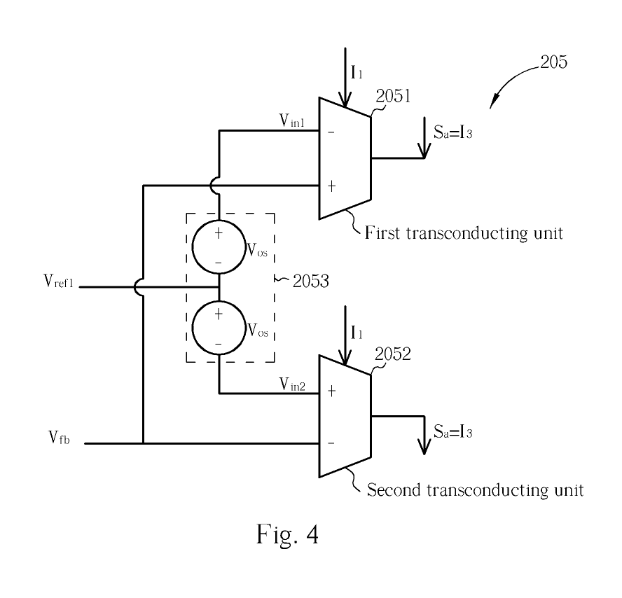

Please refer to FIG. 4. FIG. 4 is a diagram illustrating the adjusting module 205 of the power supply circuit 200 according to a first embodiment of the present invention. The adjusting module 205 is coupled to the output voltage Vₒᵤₜ and the first reference voltage V_{ref1}, and comprises a first transconducting unit 2051, a second transconducting unit 2052, and an offset voltage unit 2053. Please note that, in order to describe the spirit of the present invention more clearly, the adjusting module 205 is coupled to an output feedback voltage V_{rb}, which is generated from the output voltage Vₒᵤₜ, and the first reference voltage V_{ref1}. Furthermore, the adjusting module 205 compares the output feedback voltage V_{fb} and the first reference voltage V_{ref1} to determine an adjusting current I₃ to be the adjusting signal Sₐ. The first transconducting unit 2051 is coupled to a first input voltage Vᵢₙ₁ and the output feedback voltage V_{fb}. When the output feedback voltage V_{fb} is higher than the first input voltage Vᵢₙ₁, the first transconducting unit 2051 generates the adjusting current I₃ to make the second current I₂ be smaller than the first current I₁. The second transconducting unit 2052 is coupled to a second input voltage Vᵢₙ₂ and the output feedback voltage V_{fb}. When the output feedback voltage V_{fb} is lower than the second input voltage Vᵢₙ₂, the second transconducting unit 2052 generates the adjusting current I₃ to make the second current I₂ be larger than the first current I₁, wherein the first input voltage Vᵢₙ₁ is higher than the second input voltage Vᵢₙ₂. The voltage offset unit 2053 is coupled to the first reference voltage V_{ref1} for generating two offset voltages (i.e., +Vos, −Vos) to adjust the first reference voltage V_{ref1} to generate the first input voltage Vᵢₙ₁ and the second input voltage Vᵢₙ₂. The voltage offset unit 2053 comprises a first offset element 2053a coupled to the first reference voltage V_{ref1} for providing a first offset voltage +Vos to the first reference voltage V_{ref1} to generate the first input voltage Vᵢₙ₁, and a second offset element 2053b is coupled to the first reference voltage V_{ref1} for providing a second offset voltage −Vos to the first reference voltage V_{ref1} to generate the second input voltage Vᵢₙ₂. Therefore, the first input voltage Vᵢₙ₁ is higher than the first reference voltage V_{ref1}, and the second input voltage Vᵢₙ₂ is lower than the first reference voltage V_{ref1}.

In addition, the adjusting current I₃ is smaller than the first current I₁ in order to ensure the second current I₂, which charges the plurality of capacitors C₁˜C₄, is not zero. In other words, the adjusting module 205 compares the output feedback voltage V_{fb} and the first reference voltage V_{ref1} to determine the direction of the adjusting current I₃.

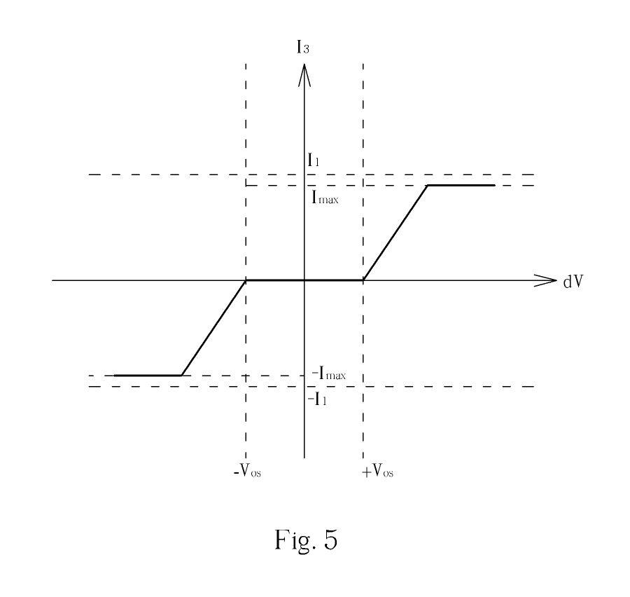

Please refer to FIG. 5, FIG. 5 is a transfer diagram between the comparing voltage and the output current of the adjusting module 205 of the power supply circuit 200, wherein the X-axis represents the voltage difference dV between the output feedback voltage V_{fb} and the first reference voltage V_{ref1}, and the Y-axis represents the magnitude of the adjusting current I₃. When the difference voltage dV is smaller than the offset voltage Vos, the adjusting current I₃ is zero; and when the difference voltage dV is larger than the offset voltage Vos, the transconducting circuit Gm outputs the adjusting current I₃, in which the magnitude of the adjusting current I₃ is proportional to the difference voltage dV. However, the adjusting current I₃ will be cut off at the maximum current Iₘₐₓ as shown in FIG. 5; as the reason has already been disclosed in the above paragraph, it is omitted here for brevity.

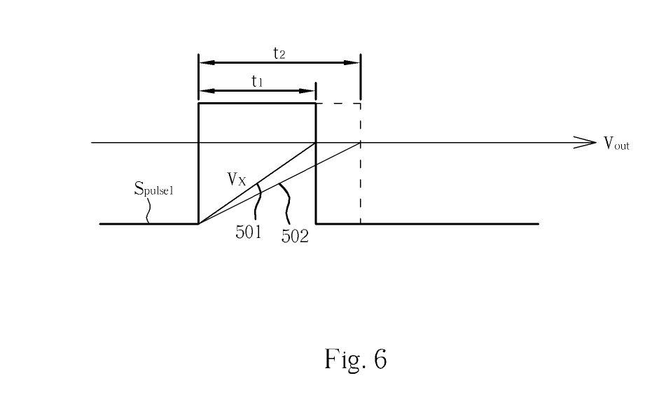

Please refer to FIG. 2 again. When the output current Iₒᵤₜ is suddenly loaded heavily, the output feedback voltage V_{fb} also decreases suddenly, then the transconducting circuit 2041 will generate more current (i.e., the compare current I_{gm}) to charge the filtering circuit 2042. However, it is well known that the filtering circuit 2042 that is installed external to the chip will not respond as quickly as the output current Iₒᵤₜ, thus causing the long deviation time of the output voltage Vₒᵤₜ. Therefore, the adjusting module 205 of the power supply circuit 200 detects the output feedback voltage V_{fb} to quickly adjust the on-time of the clock signal Sₚᵤₗₛₑ₁ of the clock signal generating module 201. Please refer to FIG. 6. FIG. 6 is a timing diagram illustrating the clock signal Sₚᵤₗₛₑ₁ of the clock signal generating module 201 when it is adjusted by the adjusting module 205. According to the transfer diagram between the comparing voltage and the output current of the adjusting module 205 as shown in FIG. 5, when the output feedback voltage V_{fb} is suddenly decreased, causing the voltage difference dV to be smaller than the offset voltage −Vos, the first transconducting unit 2051 outputs a negative adjusting current I₃ to reduce the second current I₂. Therefore, the slope of the increasing voltage Vₓ at the output current N₃ changes from the curve 501 into the curve 502, in which the slope of the curve 502 is more gradual than the curve 501, and the on-time of the clock signal Sₚᵤₗₛₑ₁ is increased from t₁ to t₂. Furthermore, the slope of the increasing voltage Vₓ is represented by the following equation:

Slope=(Vᵢₙ/R)/Cₜₒₜₐₗ.

When the on-time Tₒₙ of the clock signal Sₚᵤₗₛₑ₁ increases, the duty cycle of the controlling clock signal Sₚᵤₗₛₑ₂ also increases, thus controlling the output stage device 203 to output the required output current Iₒᵤₜ into the load immediately. The on-time of the clock signal Sₚᵤₗₛₑ₁ is represented by the following equation:

Tₒₙ=Vₒᵤₜ/Slope.

Please note that, as the capacitors C₁˜C₄ of the signal generating unit 2012 are embedded within the chip, the capacitance of the capacitors C₁˜C₄ is substantially smaller than the capacitance of the filtering circuit 2042. Accordingly, the adjusting module 205 can respond more quickly than the transconducting circuit 2041 upon the output current Iₒᵤₜ. In addition, as the pseudo-frequency is:

1/(R*Cₜₒₜₐₗ)=1/(Tₒₙ/D)=1/(R*Cₜₒₜₐₗ),

the low level time of the controlling clock signal Sₚᵤₗₛₑ₂ can be set by the pseudo-frequency, wherein D is the aspect ratio of the controlling clock signal Sₚᵤₗₛₑ₂ that corresponds to the pseudo-frequency.

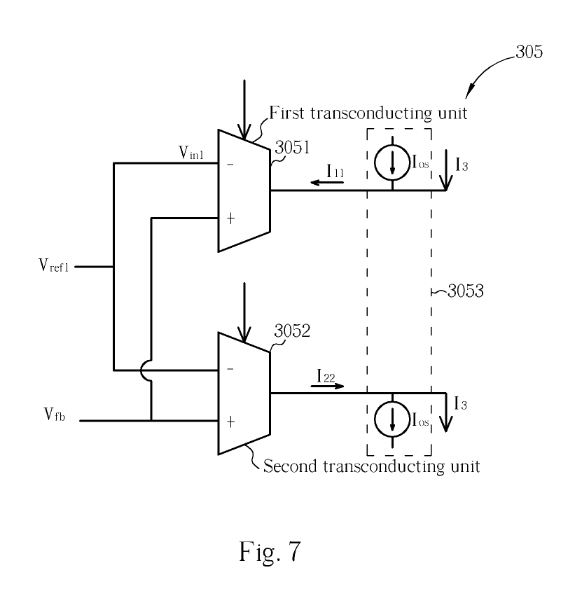

Please refer to FIG. 7. FIG. 7 is a diagram illustrating the adjusting module 305 of the power supply circuit 200 according to a second embodiment of the present invention. The adjusting module 305 comprises a first transconducting unit 3051, a second transconducting unit 3052, and a current offset unit 3053. The first transconducting unit 3051 is coupled to the first reference voltage V_{ref1} and the output feedback voltage V_{fb} for generating a first output current I₁₁ when the output feedback voltage V_{fb} is higher than the first reference voltage V_{ref1}. The second transconducting unit 3052 is coupled to the first reference voltage V_{ref1} and the output feedback voltage V_{fb} for generating a second output current I₂₂ when the output feedback voltage V_{fb} is lower than the first reference voltage V_{ref1}. The current offset unit 3053 is coupled to the first output current I₁₁ and the second output current I₂₂ for adjusting the first output current I₁₁ and the second output current I₂₂ to generate the adjusting current I₃ according to two offset currents, i.e., +Ios and −Ios. The current offset unit 3053 comprises a first offset element 3053a coupled to the first output current I₁₁ to provide a first offset current +Ios for the first output current I₁₁ to generate the adjusting current I₃, and a second offset element 3053b coupled to the second output current I₂₂ to provide a second offset current −Ios for the second output current I₂₂ to generate the adjusting current I₃.

Please note that, according to the embodiment of the present invention, the adjusting modules 205, 305 of the power supply circuit 200 detect the output feedback voltage V_{fb} for adjusting the on-time of the clock signal Sₚᵤₗₛₑ₁ of the clock signal generating module 201, but this is not a limitation of the present invention. After reading the disclosed invention, those skilled in this art can easily modify the above-mentioned embodiments to adjust the off-time of the clock signal Sₚᵤₗₛₑ₁ of the clock signal generating module 201 for controlling the output stage device 203 to output the required output current Iₒᵤₜ to the load.

Those skilled in the art will readily observe that numerous modifications and alterations of the device and method may be made while retaining the teachings of the invention.

What is claimed is:

1. A signal generating apparatus, for generating a clock signal, comprising:
an adjusting module, for generating an adjusting current according to a first reference voltage and a control voltage; and
a clock signal generating module, coupled to the adjusting module, comprising:
a current generating unit, for generating a first current;
a signal generating unit, coupled to the current generating unit and the adjusting module, for generating a voltage signal according to a second current, wherein the second current is generated according to the first current and the adjusting current; and
a comparing unit, coupled to the signal generating unit and a second reference voltage, for comparing the voltage signal and the second reference voltage to generate the clock signal.

2. The signal generating apparatus of claim 1, wherein the adjusting module is a transconductance circuit, coupled to the first reference voltage and the control voltage, for comparing the first reference voltage and the control voltage to generate the adjusting current, and the magnitude of the adjusting current is smaller than the magnitude of the first current.

3. The signal generating apparatus of claim 1, wherein the adjusting module comprises:
a first transconducting unit, coupled to a first input voltage and the control voltage, for generating the adjusting current to control the magnitude of the third current to be smaller than the first current when the control voltage is higher than the first input voltage;
a second transconducting unit, coupled to a second input voltage and the control voltage, for generating the adjusting current to control the magnitude of the third current to be larger than the first current when the control voltage is lower than the second input voltage, wherein the first input voltage is higher than the second input voltage; and
an offset voltage unit, coupled to the first reference voltage, for adjusting the first reference voltage according to at least an offset voltage to generate the first input voltage and the second input voltage.

4. The signal generating apparatus of claim 3, wherein the offset voltage unit comprises:
a first offset element, coupled to the first reference voltage, for providing a first offset voltage for the first reference voltage to generate the first input voltage; and
a second offset element, coupled to the first reference voltage, for providing a second offset voltage for the first reference voltage to generate the second input voltage;
wherein the first input voltage is higher than the first reference voltage, and the second input voltage is lower than the first reference voltage.

5. The signal generating apparatus of claim 1, wherein the adjusting module comprises:
a first transconducting unit, coupled to the first reference voltage and the control voltage, for generating a first output current when the control voltage is higher than the first reference voltage;
a second transconducting unit, coupled to the first reference voltage and the control voltage, for generating a second output current when the control voltage is lower than the first reference voltage; and
an offset current unit, coupled to the first output current and the second output current, for adjusting the first output current and the second output current to generate the adjusting current according to at least an offset current.

6. The signal generating apparatus of claim 5, wherein the offset current unit comprises:
a first offset element, coupled to the first output current, for providing a first offset current for the first output current to generate the adjusting current; and
a second offset element, coupled to the second output current, for providing a second offset current for the second output current to generate the adjusting current.

7. A power supply circuit, for generating an output voltage according to an input control voltage, comprising:
a clock signal generating module, for generating a clock signal;
a duty cycle controlling device, coupled to the clock signal generating module, for setting a duty cycle of a controlling clock signal according to the clock signal and a triggering signal, and outputting the controlling clock signal;
an output stage device, coupled to the duty cycle controlling device, for generating the output voltage and an output current that corresponds to the output voltage according to the controlling clock signal;
a detecting device, coupled to the output stage device, for detecting the output voltage and the output current to generate the triggering signal to the duty cycle controlling device; and
an adjusting module, coupled to the clock signal generating module and the output stage device, for outputting an adjusting signal to the clock signal generating module for adjusting the clock signal according to the output voltage and a first reference voltage.

8. The power supply circuit of claim 7, wherein the clock signal generating module comprises:
a current generating unit, for generating a first current;
a signal generating unit, coupled to the current generating unit and the adjusting module, for generating a voltage signal according to a second current, wherein the second current is generated according to the first current and the adjusting current; and
a comparing unit, coupled to the signal generating unit and a second reference voltage, for comparing the voltage signal and the second reference voltage to generate the clock signal.
wherein the adjusting module is a transconductance circuit, coupled to the output voltage and the first reference voltage, for comparing the output voltage and the first reference voltage to determine an adjusting current to be the adjusting signal, and the magnitude of the adjusting current is smaller than the magnitude of the first current.

9. The power supply circuit of claim 8, wherein the adjusting module comprises:
a first transconducting unit, coupled to a first input voltage and the control voltage, for generating the adjusting current to control the magnitude of the third current to be smaller than the first current when the control voltage is higher than the first input voltage;
a second transconducting unit, coupled to a second input voltage and the control voltage, for generating the adjusting current to control the magnitude of the third current to be larger than the first current when the control voltage is lower than the second input voltage, wherein the first input voltage is higher than the second input voltage; and
an offset voltage unit, coupled to the first reference voltage, for adjusting the first reference voltage according to at least an offset voltage to generate the first input voltage and the second input voltage.

10. The power supply circuit of claim 9, wherein the offset voltage unit comprises:
a first offset element, coupled to the first reference voltage, for providing a first offset voltage for the first reference voltage to generate the first input voltage; and
a second offset element, coupled to the first reference voltage, for providing a second offset voltage for the first reference voltage to generate the second input voltage;
wherein the first input voltage is higher than the first reference voltage, and the second input voltage is lower than the first reference voltage.

11. The power supply circuit of claim 8, wherein the adjusting module comprises:
a first transconducting unit, coupled to the first reference voltage and the output voltage, for generating a first output current when the output voltage is higher than the first reference voltage;
a second transconducting unit, coupled to the first reference voltage and the output voltage, for generating a second output current when the output voltage is lower than the first reference voltage; and
an offset current unit, coupled to the first output current and the second output current, for adjusting the first output current and the second output current to generate the adjusting current according to at least an offset current.

12. The power supply circuit of claim 11, wherein the offset current unit comprises:
a first offset element, coupled to the first output current, for providing a first offset current for the first output current to generate the adjusting current; and
a second offset element, coupled to the second output current, for providing a second offset current for the second output current to generate the adjusting current.

13. A signal generating method, for generating a clock signal, comprising:
generating an adjusting current according to a first reference voltage and a control voltage;
generating a first current;
generating a voltage signal according to a second current, wherein the second current is generated according to the first current and the adjusting current; and
comparing the voltage signal and a second reference voltage to generate the clock signal.

14. The signal generating method of claim 13, wherein the step of generating the adjusting current according to the first reference voltage and the control voltage compares the first reference voltage and the control voltage to generate the adjusting current, wherein the magnitude of the adjusting current is smaller than the magnitude of the first current.

15. The signal generating method of claim 13, wherein the step of generating the adjusting current according to the first reference voltage and the control voltage comprises:
generating the adjusting current to control the magnitude of the third current to be smaller than the first current when the control voltage is higher than a first input voltage;
generating the adjusting current to control the magnitude of the third current to be larger than the first current when the control voltage is lower than a second input voltage, wherein the first input voltage is higher than the second input voltage; and
adjusting the first reference voltage according to at least an offset voltage to generate the first input voltage and the second input voltage.

16. The signal generating method of claim 15, wherein the step of adjusting the first reference voltage according to the offset voltage to generate the first input voltage and the second input voltage comprises:
providing a first offset voltage for the first reference voltage to generate the first input voltage; and
providing a second offset voltage for the first reference voltage to generate the second input voltage;
wherein the first input voltage is higher than the first reference voltage, and the second input voltage is lower than the first reference voltage.

17. The signal generating method of claim 13, wherein the step of generating the adjusting current according to the first reference voltage and the control voltage comprises:
generating a first output current when the control voltage is higher than the first reference voltage;
generating a second output current when the control voltage is lower than the first reference voltage; and
adjusting the first output current and the second output current to generate the adjusting current according to at least an offset current.

18. The signal generating method of claim 17, wherein the step of adjusting the first output current and the second output current to generate the adjusting current according to the offset current comprises:
providing a first offset current for the first output current to generate the adjusting current; and
providing a second offset current for the second output current to generate the adjusting current.

19. A power supplying method, for generating an output voltage according to an input control voltage, comprising:
generating a clock signal;
setting a duty cycle of a controlling clock signal according to the clock signal and a triggering signal, and outputting the controlling clock signal;
generating the output voltage and an output current that corresponds to the output voltage according to the controlling clock signal;
detecting the output voltage and the output current to generate the triggering signal to the duty cycle controlling device; and
outputting an adjusting signal to adjust the clock signal according to the output voltage and a first reference voltage.

20. The power supplying method of claim 19, wherein the step of generating the clock signal comprises:
generating a first current;
generating a voltage signal according to a second current, wherein the second current is generated according to the first current and the adjusting signal; and
comparing the voltage signal and a second reference voltage to generate the clock signal;
wherein the step of generating the adjusting current according to the first reference voltage and the output voltage compares the first reference voltage and the control voltage to determine an adjusting current to be the adjusting signal, wherein the magnitude of the adjusting current is smaller than the magnitude of the first current.

21. The power supplying method of claim 20, wherein the step of generating the adjusting signal to adjust the clock signal according to the first reference voltage and the output voltage comprises:
generating the adjusting current to control the magnitude of the third current to be smaller than the first current when the control voltage is higher than the first input voltage;
generating the adjusting current to control the magnitude of the third current to be larger than the first current when the control voltage is lower than a second input voltage, wherein the first input voltage is higher than the second input voltage; and
adjusting the first reference voltage according to at least an offset voltage to generate the first input voltage and the second input voltage.

22. The power supplying method of claim 21, wherein the step of adjusting the first reference voltage according to the offset voltage to generate the first input voltage and the second input voltage comprises:
providing a first offset voltage for the first reference voltage to generate the first input voltage; and
providing a second offset voltage for the first reference voltage to generate the second input voltage;
wherein the first input voltage is higher than the first reference voltage, and the second input voltage is lower than the first reference voltage.

23. The power supplying method of claim 20, wherein the step of generating the clock signal comprises:
generating a first output current when the output voltage is higher than the first reference voltage;
generating a second output current when the output voltage is lower than the first reference voltage; and
adjusting the first output current and the second output current to generate the adjusting current according to at least an offset current.

24. The power supplying method of claim 23, wherein the step of adjusting the first output current and the second output current to generate the adjusting current according to the offset current comprises:
providing a first offset current for the first output current to generate the adjusting current; and
providing a second offset current for the second output current to generate the adjusting current.
